(19) United States
(12) Patent Application Publication
(10) Pub. No.: US 2019/0279556 A1
(43) Pub. Date: Sep. 12, 2019

(54) DISPLAY PANEL DRIVING CONTROL CIRCUIT AND DISPLAY APPARATUS HAVING THE SAME

(71) Applicant: Samsung Display Co., Ltd., Yongin-si (KR)

(72) Inventors: Po-Yun Park, Seoul (KR); Ga-Na Kim, Icheon-si (KR); Hong-Kyu Kim, Suwon-si (KR); Junghwan Cho, Asan-si (KR)

(21) Appl. No.: 16/351,321

(22) Filed: Mar. 12, 2019

(30) Foreign Application Priority Data
Mar. 12, 2018 (KR) 10-2018-0028825

(51) Int. Cl. G09G 3/20

(52) U.S. Cl. CPC G09G 3/2096; G09G 2370/22; G09G 2310/08

(57) ABSTRACT

A display panel driving control circuit includes a configuration channel configured to determine whether a reversible connector not having designated up and down sides is connected in a first connection state or in a second connection state, and to generate a selection signal based on the determination, and a timing control circuit configured to receive image data in the first connection state and image data in the second connection state based on the selection signal, to process the received image data in the first connection state and the received image data in the second connection state, and to generate a data signal based on the processing.

### CROSS-REFERENCE TO RELATED APPLICATION

This application claims priority to and the benefit of Korean Patent Application No. 10-2018-0028825, filed on Mar. 12, 2018 in the Korean Intellectual Property Office KIPO, the entire content of which is herein incorporated by reference.

### BACKGROUND

### 1. Field

Exemplary embodiments of the present inventive concept relate to a display panel driving control circuit and a display apparatus including the display panel driving control circuit.

### 2. Description of the Related Art

Generally, a display apparatus includes a display panel and a display panel driver. The display panel includes a plurality of gate lines, a plurality of data lines, and a plurality of pixels. The display panel driver includes a gate driver outputting gate signals to the gate lines, a data driver outputting data voltages to the data lines, and a driving controller controlling the gate driver and the data driver.

The driving controller may communicate with a host (e.g. a television set) and may receive input image data and an input control signal from the host.

To enhance convenience of a user, a connector connecting the host and the driving controller may be a reversible type, which does not have specifically designated (e.g., separate) up and down sides.

Thus, the driving controller may require a multiplexer chip to process the input data according to a first connection state of the connector and a second connection state of the connector.

When the display apparatus includes the additional multiplexer chip, a manufacturing cost may be increased and a signal of the driving controller may be attenuated.

### SUMMARY

Exemplary embodiments of the present inventive concept provide a display panel driving control circuit capable of normally processing data using a reversible connector, which does not have designated up and down sides, without a multiplexer chip.

Exemplary embodiments of the present inventive concept also provide a display apparatus including the above-mentioned display panel driving control circuit.

According to some exemplary embodiments of the present inventive concept, there is provided a display panel driving control circuit including: a configuration channel configured to determine whether a reversible connector not having designated up and down sides is connected in a first connection state or in a second connection state, and to generate a selection signal based on the determination; and a timing control circuit configured to receive image data in the first connection state and image data in the second connection state based on the selection signal, to process the received image data in the first connection state and the received image data in the second connection state, and to generate a data signal based on the processing.

In some embodiments, the display panel driving control circuit further includes a power generating circuit configured to receive power for driving the display panel driving control circuit from a host.

In some embodiments, the configuration channel is configured to communicate a power voltage used in the power generating circuit to the host.

In some embodiments, the display panel driving control circuit further includes a power generating circuit configured to receive power for driving the display panel driving control circuit from an external apparatus.

In some embodiments, the timing control circuit includes a first input port, a second input port, a third input port and a fourth input port, wherein a host is configured to output the image data through a first lane, a second lane, a third lane, and a fourth lane of the reversible connector, wherein the timing control circuit is configured to sequentially connect the first input port, the second input port, the third input port, and the fourth input port to the first lane, the second lane, the third lane, and the fourth lane of the reversible connector using the selection signal when the reversible connector has the first connecting state, and wherein the timing control circuit is configured to sequentially connect the first input port, the second input port, the third input port, and the fourth input port to the fourth lane, the third lane, the second lane, and the first lane of the reversible connector using the selection signal when the reversible connector has the second connecting state.

In some embodiments, the first lane, the second lane, the third lane, and the fourth lane of the reversible connector respectively correspond to a first RX lane, a first TX lane, a second RX lane, and a second TX lane.

In some embodiments, the timing control circuit is configured to sequentially connect the first input port and the second input port to the first lane and the second lane of the reversible connector using the selection signal when the reversible connector has the first connecting state, and the timing control circuit is configured to sequentially connect the third input port and the fourth input port to the second lane and the first lane of the reversible connector using the selection signal when the reversible connector has the second connecting state.

In some embodiments, the first lane and the second lane of the reversible connector respectively correspond to a first RX lane and a first TX lane.

In some embodiments, the configuration channel and the timing control circuit are formed as a single chip.

In some embodiments, the display panel driving control circuit further includes a low drop output regulator between a host and the configuration channel and configured to maintain a level of a power transmitted from the host to the configuration channel equal to or less than a predetermined level.

According to some exemplary embodiments of the present inventive concept, there is provided a display apparatus including: a display panel configured to display an image; a gate driver configured to output a gate signal to the display panel; a data driver configured to output a data voltage to the display panel; and a driving controller configured to control the gate driver and the data driver, wherein the driving controller includes: a configuration channel configured to determine whether a reversible connector not having designated up and down sides is connected in a first connection state or in a second connection state, and to generate a selection signal based on the determination; and a timing control circuit configured to receive image data in the first connection state and image data in the second connection state based on the selection signal, to process the received image data in the first connection state and the received image data in the second connection state, to generate a data signal corresponding to the data voltage based on the processing, and to output the data signal to the data driver.

In some embodiments, the driving controller further includes a power generating circuit configured to receive power for driving the display apparatus from a host and to generate a common voltage of the display panel, a gate on voltage of the gate driver, and a logic voltage to drive the timing control circuit.

In some embodiments, the configuration channel is configured to communicate a power voltage used in the power generating circuit to the host.

In some embodiments, the driving controller further includes a power generating circuit configured to receive power for driving the display apparatus from an external apparatus and to generate a common voltage of the display panel, a gate on voltage of the gate driver, and a logic voltage to drive the timing control circuit.

In some embodiments, the timing control circuit includes a first input port, a second input port, a third input port, and a fourth input port, wherein a host is configured to output the image data through a first lane, a second lane, a third lane and a fourth lane of the reversible connector, wherein the timing control circuit is configured to sequentially connect the first input port, the second input port, the third input port, and the fourth input port to the first lane, the second lane, the third lane, and the fourth lane of the reversible connector using the selection signal when the reversible connector has the first connecting state, and wherein the timing control circuit is configured to sequentially connect the first input port, the second input port, the third input port, and the fourth input port to the fourth lane, the third lane, the second lane, and the first lane of the reversible connector using the selection signal when the reversible connector has the second connecting state.

In some embodiments, the first lane, the second lane, the third lane, and the fourth lane of the reversible connector respectively correspond to a first RX lane, a first TX lane, a second RX lane, and a second TX lane.

In some embodiments, the timing control circuit is configured to sequentially connect the first input port and the second input port to the first lane and the second lane of the reversible connector using the selection signal when the reversible connector has the first connecting state, and the timing control circuit is configured to sequentially connect the third input port and the fourth input port to the second lane and the first lane of the reversible connector using the selection signal when the reversible connector has the second connecting state.

In some embodiments, the first lane and the second lane of the reversible connector respectively correspond to a first RX lane and a first TX lane.

According to some embodiments of the present inventive concept, in the display panel driving control circuit and the display apparatus including the display panel driving control circuit, data may be normally processed using a reversible connector, which does not have designated up and down sides, without a multiplexer chip.

Thus, the cost of the multiplexer chip may not be increased, and the manufacturing cost of the display apparatus may be reduced.

In addition, attenuation of the signal passing through the multiplexer chip may be prevented or reduced. Therefore, the display quality of the display panel may be enhanced.

### BRIEF DESCRIPTION OF THE DRAWINGS

The above and other features and aspects of the present inventive concept will become more apparent by describing in detailed exemplary embodiments thereof with reference to the accompanying drawings, in which:

FIG. 1 is a block diagram illustrating a display apparatus according to an exemplary embodiment of the present inventive concept;

FIG. 2A is a perspective view illustrating a connector connecting a host and a driving controller of FIG. 1;

FIG. 2B is a front view illustrating the connector of FIG. 2A;

FIG. 3A is a conceptual diagram illustrating positions of terminals of the connector of FIG. 2A in a first connecting state of the connector;

FIG. 3B is a conceptual diagram illustrating the positions of the terminals of the connector of FIG. 2A in a second connecting state of the connector;

FIG. 4 is a block diagram illustrating the host and the driving controller of FIG. 1;

FIG. 5 is a conceptual diagram illustrating a method of processing input image data of a timing control part of FIG. 4 according to a selection signal;

FIG. 6 is a block diagram illustrating a host and a driving controller of a display apparatus according to an exemplary embodiment of the present inventive concept; and

FIG. 7 is a block diagram illustrating a driving controller of a display apparatus according to an exemplary embodiment of the present inventive concept.

### DETAILED DESCRIPTION

Hereinafter, the present inventive concept will be explained in detail with reference to the accompanying drawings.

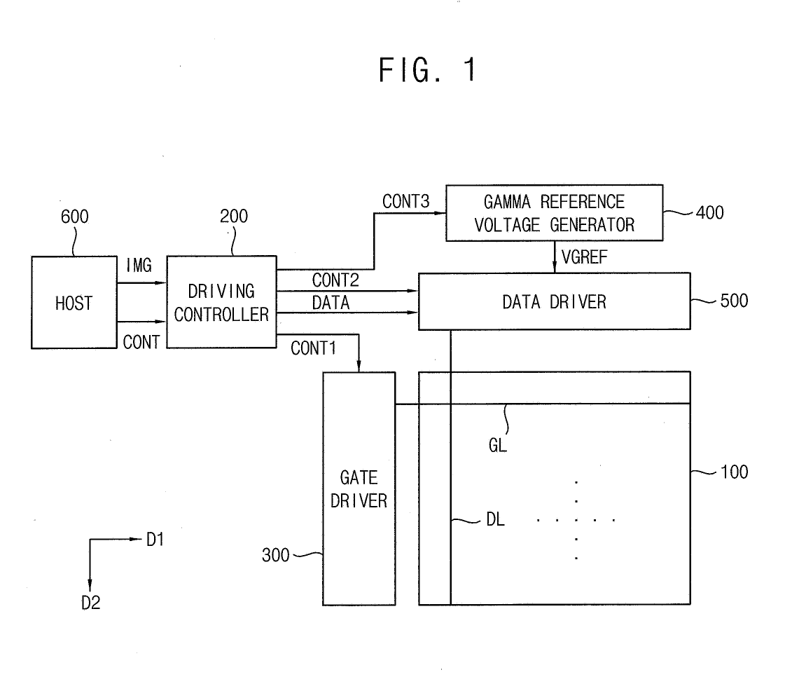

FIG. 1 is a block diagram illustrating a display apparatus according to an exemplary embodiment of the present inventive concept.

Referring to FIG. 1, the display apparatus includes a display panel 100 and a display panel driver. The display panel driver includes a driving controller 200, a gate driver 300, a gamma reference voltage generator 400, and a data driver 500.

The display apparatus further includes a host 600 outputting input image data IMG and an input control signal CONT to the driving controller 200. In some examples, the host 600 may not be included in the display apparatus. The host may be an external apparatus of the display apparatus.

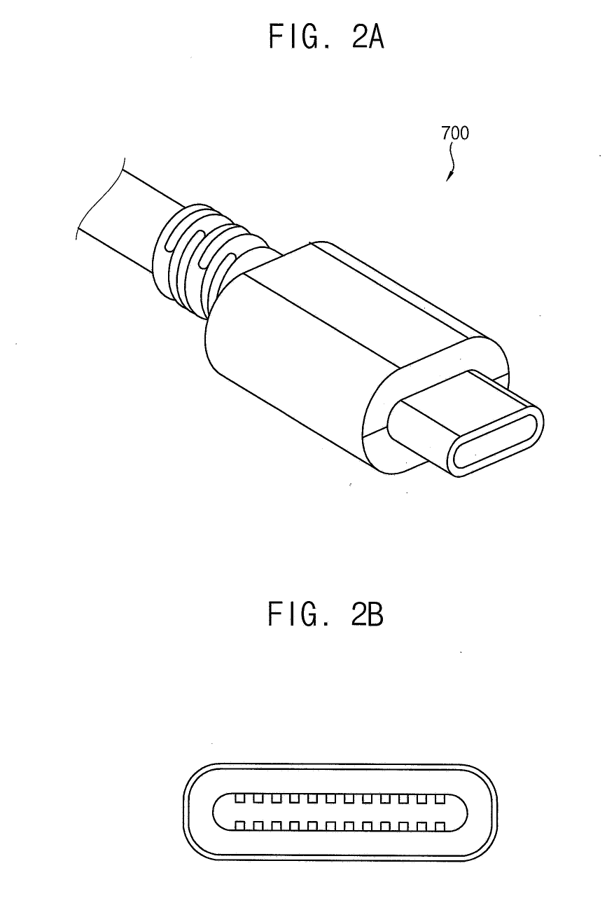

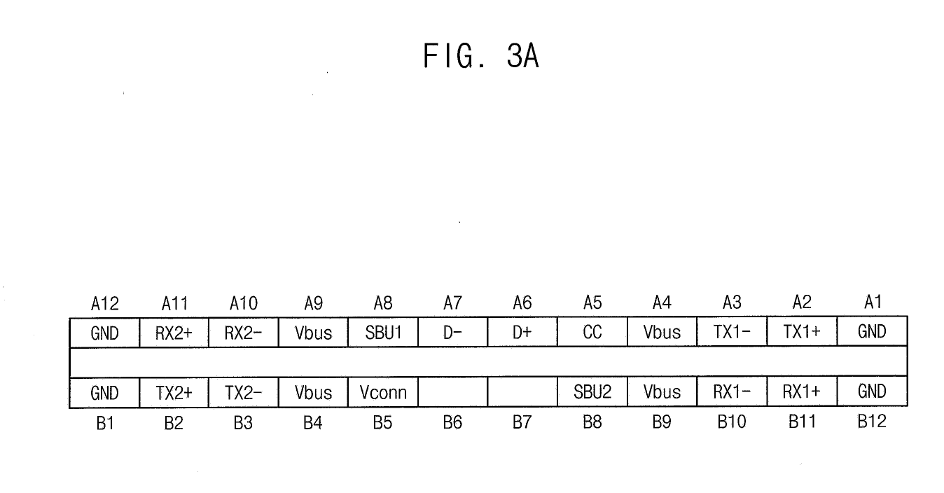

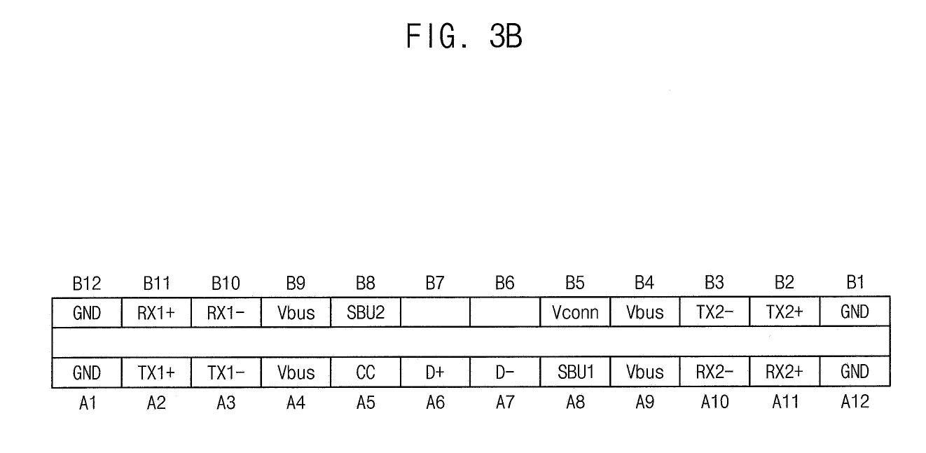

The driving controller 200 and the host 600 may be connected by a connector. The structure of the connector may be described with reference to FIGS. 2A to 3B in detail.

The display panel 100 has a display region on which an image is displayed and a peripheral region adjacent to the display region.

The display panel 100 includes a plurality of gate lines GL, a plurality of data lines DL, and a plurality of pixels connected to the gate lines GL and the data lines DL. The gate lines GL extend in a first direction D1 and the data lines DL extend in a second direction D2 crossing the first direction D1.

The driving controller 200 receives the input image data IMG and the input control signal CONT from the host 600. For example, the input image data may include red image data, green image data, and blue image data. The input image data may include white image data. The input image data may include magenta image data, yellow image data and cyan image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The gate driver 300 generates gate signals driving the gate lines GL in response to the first control signal CONT1 received from the driving controller 200. The gate driver 300 sequentially outputs the gate signals to the gate lines GL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an exemplary embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

FIG. 2A is a perspective view illustrating the connector 700 connecting the host 600 and the driving controller 200 of FIG. 1. FIG. 2B is a front view illustrating the connector 700 of FIG. 2A. FIG. 3A is a conceptual diagram illustrating positions of terminals of the connector 700 of FIG. 2A in a first connecting state of the connector 700. FIG. 3B is a conceptual diagram illustrating the positions of the terminals of the connector 700 of FIG. 2A in a second connecting state of the connector 700.

Referring to FIGS. 1 to 3B, the connector 700 may be a reversible connector so that the connector 700 may not have designated up and down sides. For example, a user may insert the connector 700 into the driving controller 200 in the first connection state. Additionally, the user may insert the connector 700 into the driving controller 200 in the second connection state. The second connection state of the connector 700 may be reversed from the first connection state of the connector 700 in a vertical direction.

The driving controller 200 may normally receive the input image data IMG from the host 600 regardless of the first connection state of the connector 700 and the second connection state of the connector 700.

The connector 700 may include twelve pins A1 to A12 disposed on a first layer and twelve pins B1 to B12 disposed on a second layer.

For example, pins A1, A12, B1 and B12 of the connector 700 may be ground pins.

Pins A2, A3, A10, A11, B2, B3, B10 and B11 of the connector 700 may be high speed data paths. When the host 600 outputs the input image data IMG to the driving controller 200 through the connector 700, the pins A2, A3, A10, A11, B2, B3, B10 and B11 of the connector 700 may be used.

Pins A4, A9, B4 and B9 of the connector 700 may be power buses to transmit power from the host 600 to the driving controller 200. In some examples, the display apparatus may be charged using pins A4, A9, B4 and B9 of the connector 700.

Pins A5 and B5 of the connector 700 may be used for configuration channels. Pins A5 and B5 of the connector 700 may determine protocol and power supply of the connection between the host 600 and the driving controller 200. The host 600 and the driving controller 200 may check the configuration therebetween through pins A5 and B5 of the connector 700. In addition, the driving controller 200 may output power information needed by the display apparatus to the host 600 through pins A5 and B5 of the connector 700. In addition, various connection states between the host 600 and the driving controller 200 may be checked through pins A5 and B5 of the connector 700. Pins B5 may be a Vconn terminal supplying power according to exemplary embodiments.

Pins A6, A7, B6 and B7 of the connector 700 operate relatively low speed data communication. Pins A6, A7, B6 and B7 of the connector 700 are data transmitting pins compatible with universal serial bus (USB) 2.0.

Pins A8 and B8 of the connector 700 are side band pins. Although pins A8 and B8 of the connector 700 may not be used for USB communication, pins A8 and B8 of the connector 700 may be reserved terminals in the data transmitting step.

FIG. 3A represents the first connection state of the connector 700. FIG. 3B represents the second connection state of the connector 700. The pins of the connector 700 in FIG. 3B are rotated by 180 degrees from the pins of the connector 700 in FIG. 3A with respect to a center of the connector 700.

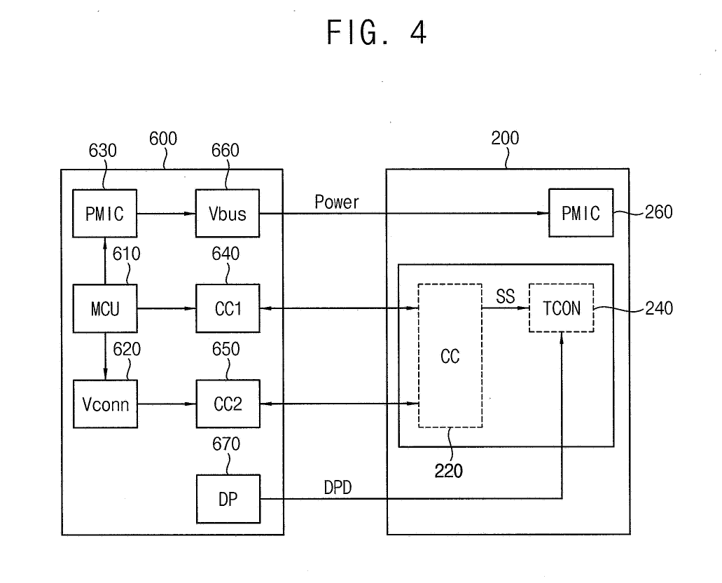

FIG. 4 is a block diagram illustrating the host 600 and the driving controller 200 of FIG. 1.

Referring to FIGS. 1 to 4, the host 600 may include a micro control unit (MCU, also referred to as a micro controller) 610, a power supply unit (Vconn, also referred to as a power supply circuit) 620, and a power generating unit (PMIC, also referred to as a power generator) 630. The micro control unit (MCU) 610 controls the general operation of the host 600. The power supply unit (Vconn) 620 may generate power for outputting to the driving controller 200. The power generating unit (PMIC) 630 may generate power used in the host 600 and power for outputting to the driving controller 200.

First and second configuration channel pins (CC1 and CC2) 640 and 650 communicate with a configuration channel part (CC) 220 of the driving controller 200. The second configuration channel pin (CC2) 650 may output the power generated by the power supply unit (Vconn) 620 to the configuration channel part (CC) 220.

A power supply pin (Vbus) 660 supplies the power to the driving controller 200. The power supply pin (Vbus) 660 may supply the power to a power generating part (PMIC) 260 of the driving controller 200.

The host 600 may further include a display port pin (DP) 670 outputting the input image data DPD to a timing control part (TCON, also referred to as a timing control circuit) 240 of the driving controller 200.

The driving controller 200 includes the configuration channel part (CC) 220 and the timing control part (TCON) 240.

The configuration channel part (CC) 220 communicates with the host 600 through the first and second configuration channel pins (CC1 and CC2) 640 and 650. The configuration channel part (CC) 220 may determine the protocol and the power supply of the connection between the host 600 and the driving controller 200.

The configuration channel part (CC) 220 determines whether the reversible connector 700, which does not have designated up and down sides, is connected in the first connection state or in the second connection state to generate a selection signal SS. For example, the configuration channel part (CC) 220 may determine the reversible connector 700 is connected in the first connection state or in the second connection state by determining whether CC1 signal is received at a fifth position from a left side on an upper layer like FIG. 3A or received at a fifth position from a right side on a lower layer like FIG. 3B. In some examples, the configuration channel part (CC) 220 may determine the reversible connector 700 is connected in the first connection state or in the second connection state using a signal of another pin.

The timing control part (TCON) 240 receives the image data DPD in the first connection state and the image data DPD in the second connection state from the host 600 based on the selection signal SS. The timing control part (TCON) 240 processes the image data DPD in the first connection state and the image data DPD in the second connection state to generate the data signal DATA. The timing control part (TCON) 240 outputs the data signal DATA to the data driver 500.

The driving controller 200 may further include the power generating part (PMIC) 260 receiving the power for driving the display apparatus from the host 600. For example, the power generating part (PMIC) 260 may generate a common voltage of the display panel 100, a gate on voltage of the gate driver 300 and a logic voltage for driving the timing control part (TCON) 240. The power generating part (PMIC) 260 may further generate a power voltage for generating the data voltage of the data driver 500.

The configuration channel part (CC) 220 may provide notice of (e.g., communicate or provide an indication of) the power voltage used in the power generating part (PMIC) 260 to the host 600. For example, the power voltage used in the power generating part (PMIC) 260 may be 5 V, 12 V or 20 V.

The power generating unit (PMIC) 630 of the host may generate the power used in the power generating part (PMIC) 260 of the driving controller 200 and may output the power to the power generating part (PMIC) 260 of the driving controller 200 through the power supply pin (Vbus) 660.

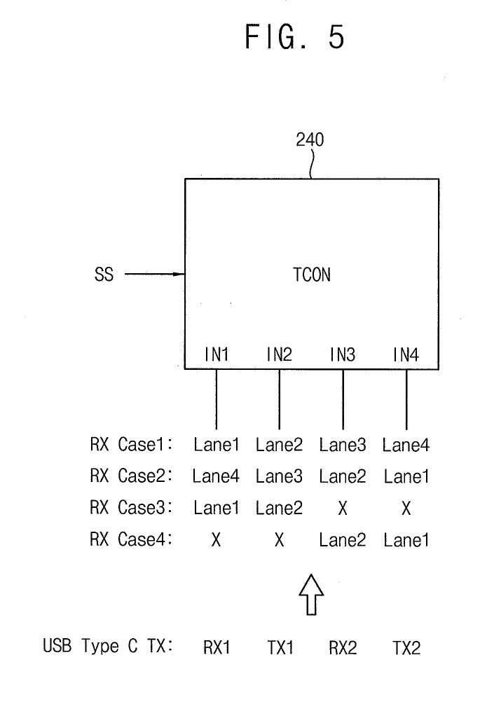

FIG. 5 is a conceptual diagram illustrating a method of processing input image data of the timing control part (TCON) 240 of FIG. 4 according to the selection signal SS.

Referring to FIGS. 1 to 5, the timing control part (TCON) 240 may include a lane swap function, which changes positions of input lanes.

The timing control part (TCON) 240 may include a first input part (e.g., a first input port) IN1, a second input part (e.g., a second input port) IN2, a third input part (e.g., a third input port) IN3, and a fourth input part (e.g., a fourth input port) IN4.

The host 600 may output the input image data through a first lane Lane1, a second lane Lane2, a third lane Lane3, and a fourth lane Lane4. The term “lane”, used throughout this disclosure, refers to one or more conductive lines or wires capable of carrying an electrical signal.

When the connection 700 has the first connecting state RX Case1, the timing control part (TCON) 240 may sequentially connect the first input part IN1, the second input part IN2, the third input part IN3, and the fourth input part IN4 to the first lane Lane1, the second lane Lane2, the third lane Lane3, and the fourth lane Lane4 using the selection signal SS.

When the connection 700 has the second connecting state RX Case2, the timing control part (TCON) 240 may sequentially connect the first input part IN1, the second input part IN2, the third input part IN3, and the fourth input part IN4 to the fourth lane Lane4, the third lane Lane3, the second lane Lane2, and the first lane Lane1 using the selection signal SS.

RX Case1 and RX Case2 respectively represent the first connection state and the second connection state of the connector 700 when the host 600 outputs the image data using four lanes of the connector 700.

For example, the first lane Lane1, the second lane Lane2, the third lane Lane3, and the fourth lane Lane4 may respectively correspond to a first receive (RX) lane (RX1+, RX1−), a first transmit (TX) lane (TX1+, TX1−), a second RX lane (RX2+, RX2−), and a second TX lane (TX2+, TX2−). For example, each of the first to fourth lanes Lane1, Lane2, Lane3 and Lane4 may correspond to two pins in a differential signal transmitting mode.

For example, the selection signal SS may have a bit to distinguish RX Case1 and RX Case2.

In addition, when the connection 700 has the first connecting state RX Case3, the timing control part (TCON) 240 may sequentially connect the first input part IN1 and the second input part IN2 to the first lane Lane1 and the second lane Lane2 using the selection signal SS.

When the connection 700 has the second connecting state RX Case4, the timing control part (TCON) 240 may sequentially connect the third input part IN3 and the fourth input part IN4 to the second lane Lane2 and the first lane Lane1 using the selection signal SS.

RX Case3 and RX Case4 respectively represent the first connection state and the second connection state of the connector 700 when the host 600 outputs the image data using two lanes of the connector 700.

For example, the first lane Lane1 and the second lane Lane2 may respectively correspond to a first RX lane (RX1+, RX1−) and a first TX lane (TX1+, TX1−).

For example, the selection signal SS may have two bits to distinguish RX Case1, RX Case2, RX Case3, and RX Case4.

According to the present exemplary embodiment, the data may be normally processed using the reversible connector 700, which does not have designated up and down sides, without a multiplexer chip.

Thus, the cost of the multiplexer chip may not be increased, and the manufacturing cost of the display apparatus may be reduced.

In addition, attenuation of the signal passing through the multiplexer chip may be prevented or reduced. Therefore, the display quality of the display panel 100 may be enhanced.

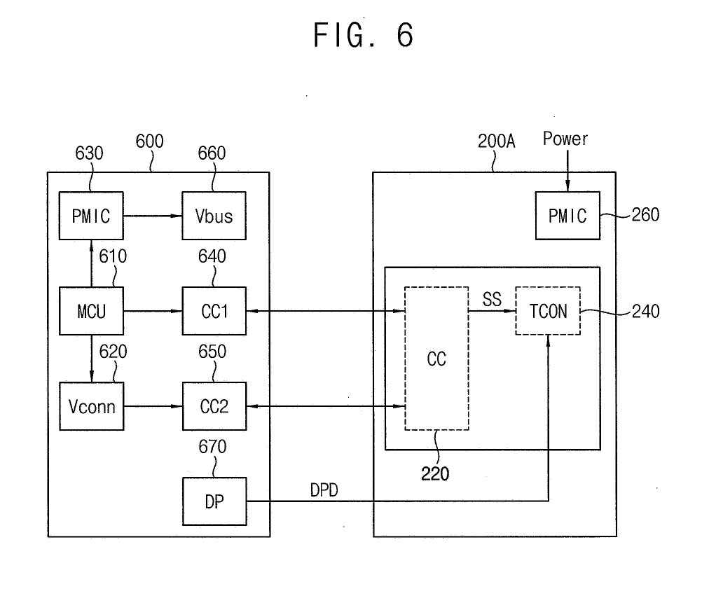

FIG. 6 is a block diagram illustrating a host 600 and a driving controller 200A of a display apparatus according to an exemplary embodiment of the present inventive concept.

The display apparatus according to the present exemplary embodiment is substantially the same as the display apparatus of the previous exemplary embodiment described with respect to FIGS. 1 to 5, except that the power generating part receives the power from outside (e.g. from an external apparatus). Thus, the same reference numerals will be used to refer to the same or like parts as those described in the previous exemplary embodiment of FIGS. 1 to 5, and any repetitive explanation concerning the above elements will be omitted.

Referring to FIGS. 1-3B and 5-6, the display apparatus includes a display panel 100 and a display panel driver. The display panel driver includes a driving controller 200A, a gate driver 300, a gamma reference voltage generator 400, and a data driver 500.

The display apparatus further includes a host 600 outputting input image data IMG and an input control signal CONT to the driving controller 200A. In some examples, the host 600 may not be included in the display apparatus. The host may be an external apparatus of the display apparatus.

The driving controller 200A and the host 600 may be connected through the connector 700. The connector 700 may be a reversible connector so that the connector 700 may not have designated up and down sides. The driving controller 200A may normally receive the input image data IMG from the host 600 regardless of the first connection state of the connector 700 and the second connection state of the connector 700.

The host 600 may include a micro control unit (MCU) 610, a power supply unit (Vconn) 620, and a power generating unit (PMIC) 630. The micro control unit (MCU) 610 controls the general operation of the host 600. The power supply unit (Vconn) 620 may generate power for outputting to the driving controller 200A. The power generating unit (PMIC) 630 may generate power used in the host 600 and power for outputting to the driving controller 200A.

The host 600 may further include a display port pin (DP) 670 outputting the input image data DPD to a timing control part (TCON) 240 of the driving controller 200A.

The driving controller 200A includes a configuration channel part (CC) 220 and the timing control part (TCON) 240.

The configuration channel part (CC) 220 determines whether the reversible connector 700, which does not have designated up and down sides, is connected in the first connection state or in the second connection state to generate a selection signal SS.

The timing control part (TCON) 240 receives the image data DPD in the first connection state and the image data DPD in the second connection state from the host 600 based on the selection signal SS. The timing control part (TCON) 240 processes the image data DPD in the first connection state and the image data DPD in the second connection state to generate the data signal DATA. The timing control part (TCON) 240 outputs the data signal DATA to the data driver 500.

In the present exemplary embodiment, the driving controller 200A may further include the power generating part (PMIC) 260 receiving the power for driving the display apparatus from outside. For example, the display apparatus may receive the power from outside using a power plug. For example, the power generating part (PMIC) 260 may generate a common voltage of the display panel 100, a gate on voltage of the gate driver 300 and a logic voltage for driving the timing control part (TCON) 240. The power generating part (PMIC) 260 may further generate a power voltage for generating the data voltage of the data driver 500.

According to the present exemplary embodiment, the data may be normally processed using the reversible connector 700, which does not have designated up and down sides, without a multiplexer chip.

Thus, the cost of the multiplexer chip may not be increased, and the manufacturing cost of the display apparatus may be reduced.

In addition, attenuation of the signal passing through the multiplexer chip may be prevented or reduced. Therefore, the display quality of the display panel 100 may be enhanced.

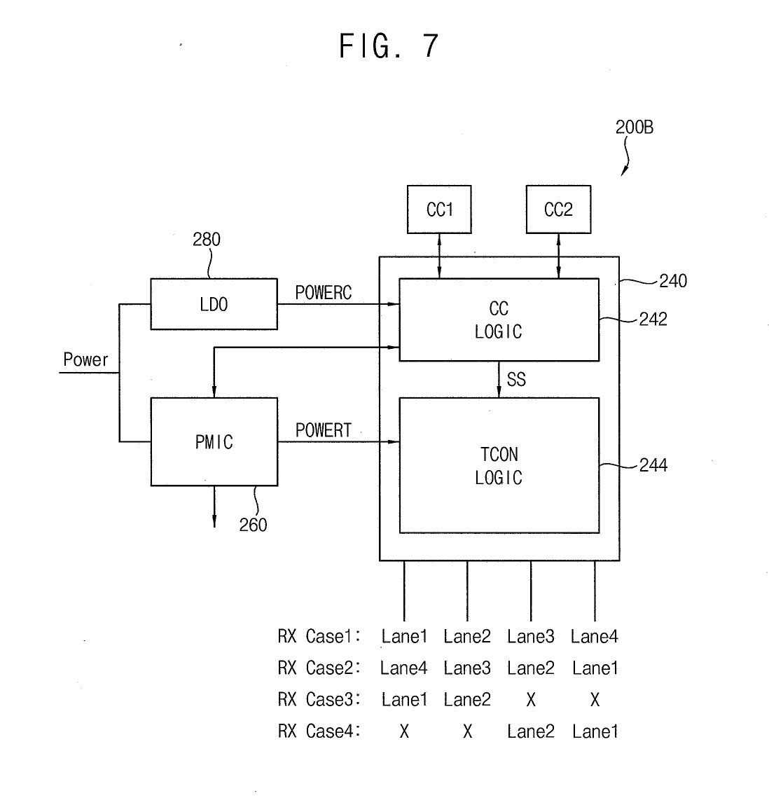

FIG. 7 is a block diagram illustrating a driving controller 200B of a display apparatus according to an exemplary embodiment of the present inventive concept.

The display apparatus according to the present exemplary embodiment is substantially the same as the display apparatus of the previous exemplary embodiment described with respect to FIGS. 1 to 5 except for the structure of the driving controller. Thus, the same reference numerals will be used to refer to the same or like parts as those described in the previous exemplary embodiment of FIGS. 1 to 5 and any repetitive explanation concerning the above elements will be omitted.

Referring to FIGS. 1-3B and 5-7, the display apparatus includes a display panel 100 and a display panel driver. The display panel driver includes a driving controller 200B, a gate driver 300, a gamma reference voltage generator 400, and a data driver 500.

The display apparatus further includes a host 600 outputting input image data IMG and an input control signal CONT to the driving controller 200B. In some examples, the host 600 may not be included in the display apparatus. The host may be an external apparatus of the display apparatus.

The driving controller 200B and the host 600 may be connected through the connector 700. The connector 700 may be a reversible connector so that the connector 700 may not have designated up and down sides. The driving controller 200B may normally receive the input image data IMG from the host 600 regardless of the first connection state of the connector 700 and the second connection state of the connector 700.

The host 600 may include a micro control unit (MCU) 610, a power supply unit (Vconn) 620 and a power generating unit (PMIC) 630. The micro control unit (MCU) 610 controls the general operation of the host 600. The power supply unit (Vconn) 620 may generate power for outputting to the driving controller 200B. The power generating unit (PMIC) 630 may generate power used in the host 600 and power for outputting to the driving controller 200B.

The host 600 may further include a display port pin (DP) 670 outputting the input image data DPD to a timing control logic (TCON LOGIC) 244 of the driving controller 2006.

The driving controller 200B includes a configuration channel logic (CC LOGIC) 242 and the timing control logic (TCON LOGIC) 244. In the present exemplary embodiment, the configuration channel logic (CC LOGIC) 242 and the timing control logic (TCON LOGIC) 244 are formed as a single chip 240; however, embodiments of the present invention are not limited thereto.

The configuration channel logic (CC LOGIC) 242 determines whether the reversible connector 700, which does not have designated up and down sides, is connected in the first connection state or in the second connection state to generate a selection signal SS.

The timing control logic (TCON LOGIC) 244 receives the image data DPD in the first connection state and the image data DPD in the second connection state from the host 600 based on the selection signal SS. The timing control logic (TCON LOGIC) 244 processes the image data DPD in the first connection state and the image data DPD in the second connection state to generate the data signal DATA. The timing control logic (TCON LOGIC) 244 outputs the data signal DATA to the data driver 500.

The driving controller 200B may further include the power generating part (PMIC) 260 receiving the power for driving the display apparatus from the host 600. For example, the power generating part (PMIC) 260 may generate a common voltage of the display panel 100, a gate on voltage of the gate driver 300, and a logic voltage for driving the timing control logic (TCON LOGIC) 244. The power generating part (PMIC) 260 may further generate a power voltage for generating the data voltage of the data driver 500.

The driving controller 200B further includes a low drop output regulator (LDO) 280 disposed between the host 600 and the configuration channel logic (CC LOGIC) 242, which is for maintaining the level of the power POWERC transmitted from the host 600 to the configuration channel logic (CC LOGIC) 242 equal to or less than a set or predetermined level.

The low drop output regulator (LDO) 280 outputs the power POWERC of the set or predetermined level to the configuration channel logic (CC LOGIC) 242 regardless of the level of the power from the power generating unit (PMIC) 630 of the host 600. Thus, the configuration channel logic (CC LOGIC) 242 normally operates regardless of initial input power level.

When the channel communication between the host 600 and the driving controller 200B is finished, the driving controller 200B provides notice of the power voltage used in the driving controller 200B to the host 600, the power generating part (PMIC) 260 generates proper power voltages and outputs the power voltages to the display panel 100, the gate driver 300, the data driver 500 and the timing control logic (TCON LOGIC) 244 according to the control of the configuration channel logic (CC LOGIC) 242.

According to the present exemplary embodiment, the data may be normally processed using the reversible connector 700, which does not have designated up and down sides, without a multiplexer chip.

Thus, the cost of the multiplexer chip may not be increased, and the manufacturing cost of the display apparatus may be reduced.

In addition, attenuation of the signal passing through the multiplexer chip may be prevented or reduced. Therefore, the display quality of the display panel 100 may be enhanced.

According to the exemplary embodiments of the display panel driving control circuit and the display apparatus, the data may be normally processed using a reversible connector, which does not have designated up and down sides, without a multiplexer chip. Thus, the display quality of the display panel may be enhanced and the manufacturing cost of the display apparatus may be reduced.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

The display panel driving control circuit and/or any other relevant devices or components, such as the timing control circuit and the configuration channel, according to embodiments of the present invention described herein may be implemented utilizing any suitable hardware, firmware (e.g. an application-specific integrated circuit), software, or a suitable combination of software, firmware, and hardware. For example, the various components of the display panel driving control circuit may be formed on one integrated circuit (IC) chip or on separate IC chips. Further, the various components of the display panel driving control circuit may be implemented on a flexible printed circuit film, a tape carrier package (TCP), a printed circuit board (PCB), or formed on a same substrate. Further, the various components of the display panel driving control circuit may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

The foregoing is illustrative of the present inventive concept and is not to be construed as limiting thereof. Although a few exemplary embodiments of the present inventive concept have been described, those skilled in the art will readily appreciate that many suitable modifications are possible in the exemplary embodiments without materially departing from the novel teachings and features of the present inventive concept. Accordingly, all such modifications are intended to be included within the scope of the present inventive concept as defined by the claims and equivalents thereof.

hat is claimed is:

1. A display panel driving control circuit comprising:
a configuration channel configured to determine whether a reversible connector not having designated up and down sides is connected in a first connection state or in a second connection state, and to generate a selection signal based on the determination; and
a timing control circuit configured to receive image data in the first connection state and image data in the second connection state based on the selection signal, to process the received image data in the first connection state and the received image data in the second connection state, and to generate a data signal based on the processing.

2. The display panel driving control circuit of claim 1, further comprising a power generating circuit configured to receive power for driving the display panel driving control circuit from a host.

3. The display panel driving control circuit of claim 2, wherein the configuration channel is configured to communicate a power voltage used in the power generating circuit to the host.

4. The display panel driving control circuit of claim 1, further comprising a power generating circuit configured to receive power for driving the display panel driving control circuit from an external apparatus.

5. The display panel driving control circuit of claim 1, wherein the timing control circuit comprises a first input port, a second input port, a third input port and a fourth input port,
wherein a host is configured to output the image data through a first lane, a second lane, a third lane, and a fourth lane of the reversible connector,
wherein the timing control circuit is configured to sequentially connect the first input port, the second input port, the third input port, and the fourth input port to the first lane, the second lane, the third lane, and the fourth lane of the reversible connector using the selection signal when the reversible connector has the first connecting state, and
wherein the timing control circuit is configured to sequentially connect the first input port, the second input port, the third input port, and the fourth input port to the fourth lane, the third lane, the second lane, and the first lane of the reversible connector using the selection signal when the reversible connector has the second connecting state.

6. The display panel driving control circuit of claim 5, wherein the first lane, the second lane, the third lane, and the fourth lane of the reversible connector respectively correspond to a first RX lane, a first TX lane, a second RX lane, and a second TX lane.

7. The display panel driving control circuit of claim 5, wherein the timing control circuit is configured to sequentially connect the first input port and the second input port to the first lane and the second lane of the reversible connector using the selection signal when the reversible connector has the first connecting state, and
wherein the timing control circuit is configured to sequentially connect the third input port and the fourth input port to the second lane and the first lane of the reversible connector using the selection signal when the reversible connector has the second connecting state.

8. The display panel driving control circuit of claim 7, wherein the first lane and the second lane of the reversible connector respectively correspond to a first RX lane and a first TX lane.

9. The display panel driving control circuit of claim 1, wherein the configuration channel and the timing control circuit are formed as a single chip.

10. The display panel driving control circuit of claim 9, further comprising a low drop output regulator between a host and the configuration channel and configured to maintain a level of a power transmitted from the host to the configuration channel equal to or less than a predetermined level.

11. A display apparatus comprising:
a display panel configured to display an image;
a gate driver configured to output a gate signal to the display panel;
a data driver configured to output a data voltage to the display panel; and
a driving controller configured to control the gate driver and the data driver,
wherein the driving controller comprises:
a configuration channel configured to determine whether a reversible connector not having designated up and down sides is connected in a first connection state or in a second connection state, and to generate a selection signal based on the determination; and
a timing control circuit configured to receive image data in the first connection state and image data in the second connection state based on the selection signal, to process the received image data in the first connection state and the received image data in the second connection state, to generate a data signal corresponding to the data voltage based on the processing, and to output the data signal to the data driver.

12. The display apparatus of claim 11, wherein the driving controller further comprises a power generating circuit configured to receive power for driving the display apparatus from a host and to generate a common voltage of the display panel, a gate on voltage of the gate driver, and a logic voltage to drive the timing control circuit.

13. The display apparatus of claim 12, wherein the configuration channel is configured to communicate a power voltage used in the power generating circuit to the host.

14. The display apparatus of claim 11, wherein the driving controller further comprises a power generating circuit configured to receive power for driving the display apparatus from an external apparatus and to generate a common voltage of the display panel, a gate on voltage of the gate driver, and a logic voltage to drive the timing control circuit.

15. The display apparatus of claim 11, wherein the timing control circuit comprises a first input port, a second input port, a third input port, and a fourth input port,
wherein a host is configured to output the image data through a first lane, a second lane, a third lane and a fourth lane of the reversible connector,
wherein the timing control circuit is configured to sequentially connect the first input port, the second input port, the third input port, and the fourth input port to the first lane, the second lane, the third lane, and the fourth lane of the reversible connector using the selection signal when the reversible connector has the first connecting state, and
wherein the timing control circuit is configured to sequentially connect the first input port, the second input port, the third input port, and the fourth input port to the fourth lane, the third lane, the second lane, and the first lane of the reversible connector using the selection signal when the reversible connector has the second connecting state.

16. The display apparatus of claim 15, wherein the first lane, the second lane, the third lane, and the fourth lane of the reversible connector respectively correspond to a first RX lane, a first TX lane, a second RX lane, and a second TX lane.

17. The display apparatus of claim 15, wherein the timing control circuit is configured to sequentially connect the first input port and the second input port to the first lane and the second lane of the reversible connector using the selection signal when the reversible connector has the first connecting state, and
wherein the timing control circuit is configured to sequentially connect the third input port and the fourth input port to the second lane and the first lane of the reversible connector using the selection signal when the reversible connector has the second connecting state.

18. The display apparatus of claim 17, wherein the first lane and the second lane of the reversible connector respectively correspond to a first RX lane and a first TX lane.
